(19) United States
(12) Patent Application Publication
(10) Pub. No.: US 2025/0291937 A1
(43) Pub. Date: Sep. 18, 2025

(54) EVALUATION SUPPORT SYSTEM AND EVALUATION SUPPORT METHOD

(71) Applicant: Panasonic Automotive Systems Co., Ltd., Kanagawa (JP)

(72) Inventors: Daiki OKAZAKI, Kanagawa (JP); Jun ANZAI, Kanagawa (JP); Masato TANABE, Kanagawa (JP)

(73) Assignee: Panasonic Automotive Systems Co., Ltd., Kanagawa (JP)

(21) Appl. No.: 19/075,362

(22) Filed: Mar. 10, 2025

(30) Foreign Application Priority Data
Mar. 13, 2024 (JP) 2024-039465
Sep. 11, 2024 (JP) 2024-157078

(51) Int. Cl. G06F 21/57

(52) U.S. Cl. CPC G06F 21/577

(57) ABSTRACT

An evaluation support system includes a threat concatenator that performs first association processing for concatenating at least part of threat analysis information with first evaluation specification information, the threat analysis information indicating a result of analysis of a threat to information security of an evaluation target device, the first evaluation specification information indicating one or more evaluation specifications of the evaluation target device; a vulnerability concatenator that performs second association processing for concatenating at least part of vulnerability analysis information with the first evaluation specification information, the vulnerability analysis information indicating a result of analysis of the vulnerability of the information security of the evaluation target device; and a re-definer that generates and outputs second evaluation specification information by re-defining, based on the first association processing and the second association processing, the one or more evaluation specifications indicated by the first evaluation specification information.

### CROSS REFERENCE TO RELATED APPLICATIONS

The present application is based on and claims priority of Japanese Patent Application No. 2024-039465 filed on Mar. 13, 2024 and Japanese Patent Application No. 2024-157078 filed on Sep. 11, 2024.

### FIELD

The present disclosure relates to an evaluation support system or the like that supports an evaluation of an evaluation target device.

### BACKGROUND

For example, Patent Literature (PTL) 1 discloses a risk evaluation countermeasure planning system as an evaluation support system. This risk evaluation countermeasure planning system plans a countermeasure against attacks on a system to be evaluated and plans a security test. It can also be said that planning a security test refers to defining evaluation specifications.

### CITATION LIST

### Patent Literature

PTL 1: WO2020/202934

### SUMMARY

However, the risk evaluation countermeasure planning system disclosed in PTL 1 described above can be improved upon.

In view of this, the present disclosure provides an evaluation support system or the like that can improve upon the above related art.

An evaluation support system according to one aspect of the present disclosure is an evaluation support system for supporting an evaluation of an evaluation target device. The evaluation support system includes memory that stores a program, and a processor. The processor executes the program to operate as a threat concatenator that performs first association processing for concatenating at least part of threat analysis information with first evaluation specification information, the threat analysis information indicating a result of analysis of a threat to information security of the evaluation target device, the first evaluation specification information indicating one or more evaluation specifications of the evaluation target device, a vulnerability concatenator that performs second association processing for concatenating at least part of vulnerability analysis information with the first evaluation specification information, the vulnerability analysis information indicating a result of analysis of vulnerability of the information security of the evaluation target device, and a re-definer that generates and outputs second evaluation specification information by redefining, based on the first association processing and the second association processing, the one or more evaluation specifications indicated by the first evaluation specification information.

It is to be noted that such a generic or specific aspect of the present disclosure may be embodied as a device, a method, an integrated circuit, a computer program, or a computer-readable recording medium such as a CD-ROM, or may be embodied as any combination of a device, a method, an integrated circuit, a computer program, and a recording medium. The recording medium may be a non-transitory recording medium.

The evaluation support system according to the present disclosure can further improve upon the above related art.

Further advantages and effects achieved by one aspect of the present disclosure become apparent from the specification and the drawings. These advantages and/or the effects are provided by configurations to be described in embodiments and in the specification and drawings, but not necessarily all of the configurations are required.

### BRIEF DESCRIPTION OF DRAWINGS

These and other advantages and features of the present disclosure will become apparent from the following description thereof taken in conjunction with the accompanying drawings that illustrate a specific embodiment of the present disclosure.

FIG. 1 is a diagram showing one example of a configuration of a development system according to Embodiment 1.

FIG. 2 is a diagram for illustratively describing part of threat analysis conducted by a threat analyzer according to Embodiment 1.

FIG. 3 is a diagram showing one schematic example of threat analysis information that is generated and output by the threat analyzer according to Embodiment 1.

FIG. 4 is a diagram showing one schematic example of vulnerability analysis information that is generated and output by a vulnerability analyzer according to Embodiment 1.

FIG. 5 is a diagram showing one schematic example of first evaluation specification information that is generated and output by an evaluation specification definer according to Embodiment 1.

FIG. 6 is a diagram for describing processing operations of an evaluation support system according to Embodiment 1.

FIG. 7 is a diagram showing one example of evaluated specification information according to Embodiment 1.

FIG. 8 is a diagram showing one specific example of the threat analysis information according to Embodiment 1.

FIG. 9 is a diagram showing one specific example of the vulnerability analysis information according to Embodiment 1.

FIG. 10 is a diagram showing one specific example of evaluation specification information according to second Embodiment 1.

FIG. 11 is a diagram showing one specific example of part of the evaluated specification information according to Embodiment 1.

FIG. 12 is a sequence diagram showing one example of processing operations of the development system according to Embodiment 1.

FIG. 13 is a flowchart showing one example of the processing operations of the evaluation support system according to Embodiment 1.

FIG. 14 is a diagram showing one example of a configuration of a development system according to Embodiment 2.

FIG. 15 is a diagram showing one example of a configuration of a development system according to Embodiment 3.

### DESCRIPTION OF EMBODIMENTS

### (Underlying Knowledge Forming Basis of the Present Disclosure)

The inventors of the present disclosure have found the following problems with the risk evaluation countermeasure planning system according to PTL 1 described in “Background”.

In the risk evaluation countermeasure planning system according to PTL 1, threat analysis, vulnerability analysis, and a security test, which are conducted as countermeasures for security in product development, are not associated with one another. Thus, there is the problem that an evaluation target device that is a product may not be evaluated properly. For example, necessary evaluations may not be conducted. That is, the risk evaluation countermeasure planning system according to PTL 1 described above has a problem in that it is difficult to effectively support the evaluation of the evaluation target device.

An evaluation support system according to one aspect of the present disclosure is an evaluation support system for supporting an evaluation of an evaluation target device. The evaluation support system includes memory that stores a program, and a processor. The processor executes the program to operate as a threat concatenator that performs first association processing for concatenating at least part of threat analysis information with first evaluation specification information, the threat analysis information indicating a result of analysis of a threat to information security of the evaluation target device, the first evaluation specification information indicating one or more evaluation specifications of the evaluation target device, a vulnerability concatenator that performs second association processing for concatenating at least part of vulnerability analysis information with the first evaluation specification information, the vulnerability analysis information indicating a result of analysis of vulnerability of the information security of the evaluation target device, and a re-definer that generates and outputs second evaluation specification information by redefining, based on the first association processing and the second association processing, the one or more evaluation specifications indicated by the first evaluation specification information.

Through the first association processing, the second association processing, and the re-definition, the one or more evaluation specifications included in the second evaluation specification information are associated with the threat analysis information and the vulnerability analysis information. That is, the security evaluation, the threat analysis, and the vulnerability analysis performed by the evaluation target device have not conventionally been associated with one another, but the first aspect enables the association of them. As a result, it becomes more likely that the evaluation target device can be evaluated exhaustively while avoiding omissions of necessary evaluations. That is, it is possible to reduce the possibility of incomplete security evaluations of the evaluation target device. This allows effective support of the evaluation of the evaluation target device.

In an evaluation support system according to a second aspect, the first evaluation specification information may indicate, for each evaluation item, an evaluation specification corresponding to the evaluation item, and the threat concatenator may perform the first association processing by concatenating, for each evaluation item in the first evaluation specification information, information indicating a countermeasure against the threat with the first evaluation specification information to associate the information with the evaluation specification corresponding to the evaluation item, the information indicating a result of analysis of the evaluation item and being included in the threat analysis information. Note that the second aspect may depend on the first aspect.

Through first the association processing, the countermeasure against the threat is associated with each evaluation specification. Thus, the associated countermeasures can be referenced to for the evaluation conducted in accordance with the first evaluation specification information that has undergone the first association processing. This allows more effective support of the evaluation of the evaluation target device.

In an evaluation support system according to the third aspect, the first evaluation specification information may indicate, for each evaluation item, an evaluation specification corresponding to the evaluation item, and the vulnerability concatenator may perform the second association processing by concatenating, for each evaluation item in the first evaluation specification information, identification information on the vulnerability with the first evaluation specification information to associate the identification information with the evaluation specification corresponding to the evaluation item, the identification information indicating a result of analysis of the evaluation item and being included in the vulnerability analysis information. Note that the third aspect may depend on the first or second aspect.

Through the second association processing, the identification information on the vulnerability is associated with each evaluation specification. Thus, the associated vulnerability can be referenced to for the evaluation conducted in accordance with the second evaluation specification information that has undergone the second association processing. This allows more effective support of the evaluation of the evaluation target device.

In an evaluation support system according to a fourth aspect, when the vulnerability analysis information includes identification information on the vulnerability corresponding to a missing evaluation specification that is an evaluation specification not indicated by the first evaluation specification information, the re-definer may re-define the one or more evaluation specifications indicated by the first evaluation specification information by adding the missing evaluation specification and the identification information on the vulnerability corresponding to the missing evaluation specification to the first evaluation specification information that has undergone the first association processing and the second association processing. Note that the fourth aspect may depend on the third aspect.

Through the re-definition, the first evaluation specification information is updated to the second evaluation specification information that includes the missing evaluation specification and the identification information on the vulnerability. This allows the evaluation target device to be evaluated exhaustively while avoiding omissions of necessary evaluations.

In an evaluation support system according to a fifth aspect, the processor may further operate as a feedback device that feeds back the second evaluation specification information as evaluated specification information to a threat analyzer and a vulnerability analyzer, the second evaluation specification information indicating a result of the evaluation of the evaluation target device obtained by the evaluation conducted in accordance with the second evaluation specification information, the threat analyzer may generate the threat analysis information by analyzing the threat to the evaluation target device, and the vulnerability analyzer may generate the vulnerability analysis information by analyzing the vulnerability of the evaluation target device. Note that the fifth aspect may depend on any one of the first to fourth aspects.

In this way, the evaluated specification information is fed back to the threat analyzer and the vulnerability analyzer. Thus, if the evaluated specification information indicates a good evaluation result for the evaluation specification, the threat analyzer can assure the result of analysis of the threat. For example, if the analysis result indicates a countermeasure against the threat, the threat analyzer can assure the effectiveness of the countermeasure. On the other hand, if the evaluated specification information indicates a bad evaluation result for the evaluation specification, the threat analyzer can improve the threat analysis. For example, if the analysis result indicates a countermeasure against the threat, the threat analyzer can improve the countermeasure. As a result, the accuracy of planning the countermeasure is improved. The vulnerability analyzer can improve the accuracy of the vulnerability analysis in accordance with the evaluation result indicated by the evaluated specification information. That is, the fifth aspect allows not only one-way processing from the threat analysis and the vulnerability analysis to the evaluation, but also the feedback of the evaluation result to the threat analysis and the vulnerability analysis. This allows effective risk management of the evaluation target device.

An evaluation support system according to a sixth aspect is an evaluation support system for supporting an evaluation of an evaluation target device. The evaluation support system includes memory that stores a program, and a processor. The processor executes the program to operate as a threat concatenator that performs first association processing for concatenating at least part of threat analysis information with first evaluation specification information, the threat analysis information indicating a result of analysis of a threat to information security of the evaluation target device, the first evaluation specification information indicating one or more evaluation specifications of the evaluation target device, and a re-definer that generates and outputs second evaluation specification information by re-defining, based on the first association processing, the one or more evaluation specifications indicated by the first evaluation specification information.

This system achieves the same functional effects for the threat to the evaluation target device as the evaluation support system according to the first aspect.

In an evaluation support system according to a seventh aspect, the first evaluation specification information may indicate, for each evaluation item, an evaluation specification corresponding to the evaluation item, and the threat concatenator may perform the first association processing by concatenating, for each evaluation item in the first evaluation specification information, information indicating a countermeasure against the threat with the first evaluation specification information to associate the information with the evaluation specification corresponding to the evaluation item, the information indicating a result of analysis of the evaluation item and being included in the threat analysis information. Note that the seventh aspect may depend on the sixth aspect.

This system achieves the same functional effects as the evaluation support system according to the second aspect.

In an evaluation support system according to an eighth aspect, when the threat analysis information includes information on a countermeasure against the threat corresponding to a missing evaluation specification that is an evaluation specification not indicated by the first evaluation specification information, the re-definer may re-define the one or more evaluation specifications indicated by the first evaluation specification information by adding the missing evaluation specification the and information on the countermeasure against the threat corresponding to the missing evaluation specification to the first evaluation specification information that has undergone the first association processing. Note that the eighth aspect may depend on the sixth or seventh aspect.

Through the re-definition, the first evaluation specification information is updated to the second evaluation specification information that includes the missing evaluation specification and the countermeasure against the threat. This allows the evaluation target device to be evaluated exhaustively while avoiding omissions of necessary evaluations.

In an evaluation support system according to a ninth aspect, the processor may further operate as a feedback device that feeds back the second evaluation specification information as evaluated specification information to the threat analyzer, the second evaluation specification information indicating a result of the evaluation of the evaluation target device obtained by the evaluation conducted in accordance with the second evaluation specification information, and the threat analyzer may generate the threat analysis information by performing threat analysis on the evaluation target device. Note that the ninth aspect may depend on any one of the sixth to eighth aspects.

This system achieves the same functional effects for the threat to the evaluation target device as the evaluation support system according to the fifth aspect.

An evaluation support system according to a tenth aspect of the present disclosure is an evaluation support system for supporting an evaluation of an evaluation target device. The evaluation support system includes memory that stores a program, and a processor. The processor executes the program to operate as a vulnerability concatenator that performs second association processing for concatenating at least part of vulnerability analysis information with first evaluation specification information, the vulnerability analysis information indicating a result of analysis of vulnerability of information security of the evaluation target device, the first evaluation specification information indicating one or more evaluation specifications of the evaluation target device, and a re-definer that generates and outputs second evaluation specification information by re-defining, based on the second association processing, the one or more evaluation specifications indicated by the first evaluation specification information.

This system achieves the same functional effects for the vulnerability of the evaluation target device as the evaluation support system according to the first aspect.

In an evaluation support system according to an eleventh aspect, the first evaluation specification information may indicate, for each evaluation item, an evaluation specification corresponding to the evaluation item, and the vulnerability concatenator may perform the second association processing by concatenating, for each evaluation item in the first evaluation specification information, identification information on the vulnerability with the first evaluation specification information to associate the identification information with the evaluation specification corresponding to the evaluation item, the identification information indicating a result of analysis of the evaluation item and being included in the vulnerability analysis information. Note that the eleventh aspect may depend on the tenth aspect.

This system achieves the same functional effects as the evaluation support system according to the third aspect.

In an evaluation support system according to a twelfth aspect, when the vulnerability analysis information includes identification information on the vulnerability corresponding to a missing evaluation specification that is an evaluation specification not indicated by the first evaluation specification information, the re-definer may re-define the one or more evaluation specifications indicated by the first evaluation specification information by adding the missing evaluation specification and the identification information on the vulnerability corresponding to the missing evaluation specification to the first evaluation specification information that has undergone the second association processing. Note that the twelfth aspect may depend on the tenth or eleventh aspect.

This system achieves the same functional effects as the evaluation support system according to the fourth aspect.

In an evaluation support system according to a thirteenth aspect, the processor may further operate as a feedback device that feeds back the second evaluation specification information as evaluated specification information to the vulnerability analyzer, the second evaluation specification information indicating a result of the evaluation of the evaluation target device obtained by the evaluation conducted in accordance with the second evaluation specification information, and the vulnerability analyzer may generate the vulnerability analysis information by performing vulnerability analysis on the evaluation target device. Note that the thirteenth aspect may depend on any one of the tenth to twelfth aspects.

This system achieves the same functional effects for the vulnerability of the evaluation target device as the evaluation support system according to the fifth aspect.

Embodiments will be described hereinafter in detail with reference to the drawings.

Note that each embodiment described below illustrates a generic or specific example of the present disclosure. Numerical values, shapes, materials, constituent elements, arrangement positions and connection forms of constituent elements, steps, a sequence of steps, and so on in the following embodiments are mere examples and do not intend to limit the scope of the present disclosure. Among the constituent elements described in the following embodiments, those that are recited in none of the independent claims, which represent the broadest concept, are described as optional constituent elements.

Each drawing is a schematic diagram and does not necessarily provide precise depiction. Throughout the drawings, the same constituent elements are given the same reference signs.

### Embodiment 1

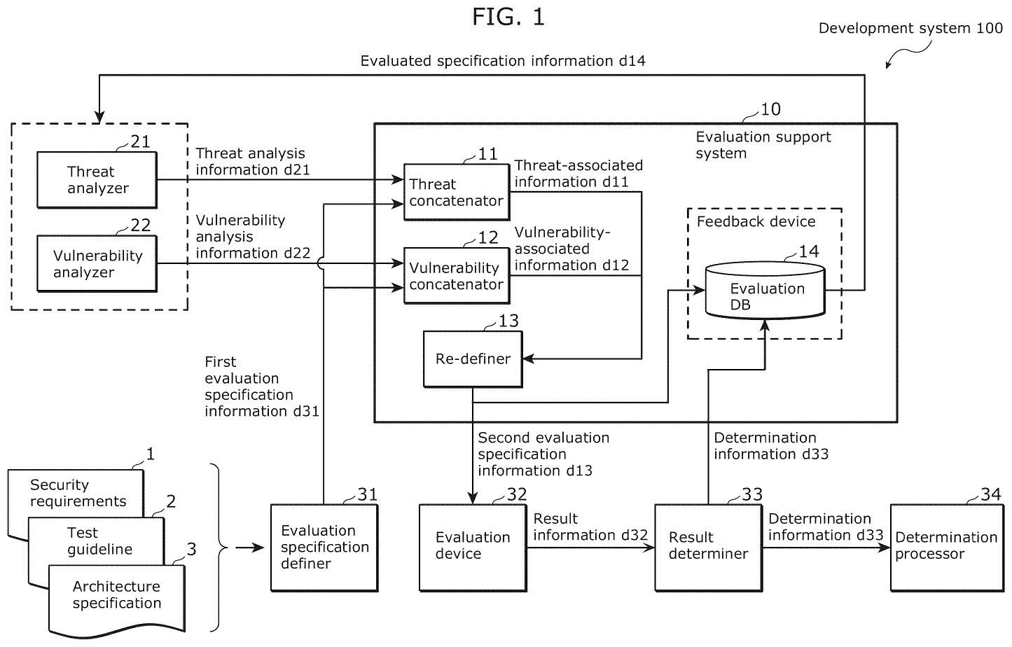

FIG. 1 is a diagram showing one example of a configuration of a development system according to the present embodiment.

Development system 100 according to the present embodiment is a system for supporting development of, for example, an evaluation target device (e.g., product) such as an electronic control unit (ECU) mounted on a vehicle. Development system 100 may also be a system that is compliant with International Organization for Standardization/Society of Automotive Engineers (ISO/SAE) 21434 standards. Development system 100 includes threat analyzer 21, vulnerability analyzer 22, evaluation specification definer 31, evaluation device 32, result determiner 33, determination processor 34, and evaluation support system 10.

Threat analyzer 21 generates threat analysis information d21 by analyzing a threat to the evaluation target device. Threat analysis information d21 indicates the result of analysis of a threat to information security of the evaluation target device. For example, threat analyzer 21 may plan a countermeasure against a threat by threat analysis and generates threat analysis information d21 indicating the countermeasure. Threat analyzer 21 may identify and evaluate a threat that the evaluation target device may face. The threat includes all elements that may affect the security of the evaluation target device, such as a malicious attacker and natural disasters.

Vulnerability analyzer 22 generates and output vulnerability analysis information d22 by analyzing vulnerability of the evaluation target device. Vulnerability analysis information d22 indicates the result of analysis of vulnerability of information security of the evaluation target device. For example, vulnerability analyzer 22 may determine whether or not the evaluation target device is vulnerable to each element and generate vulnerability analysis information d22 indicating the result of the determination. Vulnerability analyzer 22 may also identify and evaluate vulnerability of the evaluation target device. It can also be said that vulnerability refers to a weak point of the evaluation target device that cannot be defended against attacks. Vulnerability analyzer 22 may also identify the degree of seriousness of vulnerability as vulnerability analysis. The degree of seriousness may, for example, be a value of a common vulnerability scoring system (CVSS).

Evaluation specification definer 31 generates and output first evaluation specification information d31 that indicates one or more evaluation specifications of the evaluation target device. For example, evaluation specification definer 31 may acquire security requirement 1, test guideline 2, and architecture specification 3 of the evaluation target device and generate first evaluation specification information d31 based on the acquired information. First evaluation specification information d31 indicates, for each evaluation item, an evaluation specification corresponding to the evaluation item.

Evaluation device 32 acquires second evaluation specification information d13 generated based on first evaluation specification information d31 by evaluation support system 10 and evaluates (i.e., tests) the evaluation target device in accordance with second evaluation specification information d13. Then, evaluation device 32 outputs, as result information d32, information indicating the result of the evaluation. For example, result information d32 may indicate the result of the evaluation for each evaluation item. Note that the evaluation of the evaluation target device refers to the evaluation of the security status and may, for example, be a fuzzing test, a vulnerability test, a functional test, or a penetration test. The evaluation specifications refer to specifications for use in the evaluations.

Result determiner 33 acquires result information d32 that is output from evaluation device 32 and generates determination information d33 by determining the result of the evaluation for each evaluation item indicated by result information d32. Determination information d33 indicates whether the result of the evaluation for each evaluation item is, for example, OK or NG. NG indicates that the result of the evaluation is not OK, i.e., unsatisfactory. Then, result determiner 33 outputs determination information d33 to evaluation support system 10 and determination processor 34.

Determination processor 34 acquires determination information d33 output from result determiner 33 and outputs an NG report about NG evaluation items and their evaluation results indicated by determination information d33. Determination processor 34 may also make a suggestion for improvement in the countermeasure for the NG evaluation items.

Evaluation support system 10 according to the present embodiment is an evaluation support system for supporting the evaluation of the evaluation target device, and generates second evaluation specification information d13 by performing processing such as re-definition on first evaluation specification information d31. Then, evaluation support system 10 feeds back evaluated specification information d14 to threat analyzer 21 and vulnerability analyzer 22, the evaluated specification information being configured by adding determination information d33 described above to second evaluation specification information d13.

Evaluation support system 10 as described above includes threat concatenator 11, vulnerability concatenator 12, re-definer 13, and evaluation database (also referred to as “evaluation DB”) 14.

Threat concatenator 11 acquires threat analysis information d21 from threat analyzer 21 and acquires first evaluation specification information d31 from evaluation specification definer 31. Then, threat concatenator 11 associates threat analysis information d21 with first evaluation specification information d31. That is, threat concatenator 11 performs first association processing for connecting at least part of threat analysis information d21 with first evaluation specification information d31 that indicates one or more evaluation specifications of the evaluation target device. Threat concatenator 11 outputs threat-associated information d11 indicating the result of the first association processing to re-definer 13.

Vulnerability concatenator 12 acquires vulnerability analysis information d22 from vulnerability analyzer 22 and acquires first evaluation specification information d31 from evaluation specification definer 31. Then, vulnerability concatenator 12 associates vulnerability analysis information d22 with first evaluation specification information d31. That is, vulnerability concatenator 12 performs second association processing for concatenating at least part of vulnerability analysis information d22 with first evaluation specification information d31. Vulnerability concatenator 12 outputs vulnerability-associated information d12 indicating the result of the second association processing to re-definer 13.

Re-definer 13 generates and outputs second evaluation specification information d13 by re-defining, based on the first association processing and the second association processing, the one or more evaluation specifications indicated by first evaluation specification information d31. That is, re-definer 13 acquires threat-associated information d11 from threat concatenator 11, acquires vulnerability-associated information d12 from vulnerability concatenator 12, and generates second evaluation specification information d13 based on threat-associated information d11 and vulnerability-associated information d12. Then, re-definer 13 outputs second evaluation specification information d13 to evaluation device 32 and stores second evaluation specification information d13 in evaluation database 14.

Evaluation database 14 is a recording medium for storing information such as second evaluation specification information d13. Evaluation database 14 may, for example, be a hard disk drive (HDD), random access memory (RAM), read-only memory (ROM), or semiconductor memory. Evaluation database 14 may be volatile or non-volatile.

Evaluation database 14 also stores evaluated specification information d14. That is, result determiner 33 stores determination information d33 in evaluation database 14. At this time, result determiner 33 generates evaluated specification information d14 by adding determination information d33 to second evaluation specification information d13 already stored in evaluation database 14. In this way, evaluated specification information d14 is stored in evaluation database 14. Then, evaluated specification information d14 stored in evaluation database 14 is fed back to threat analyzer 21 and vulnerability analyzer 22. That is, evaluation database 14 according to the present embodiment is configured as a feedback device that feeds back second evaluation specification information d13 as evaluated specification information d14 to threat analyzer 21 and vulnerability analyzer 22, the second evaluation specification information indicating the result of the evaluation of the evaluation target device obtained by the evaluation conducted in accordance with second evaluation specification information d13.

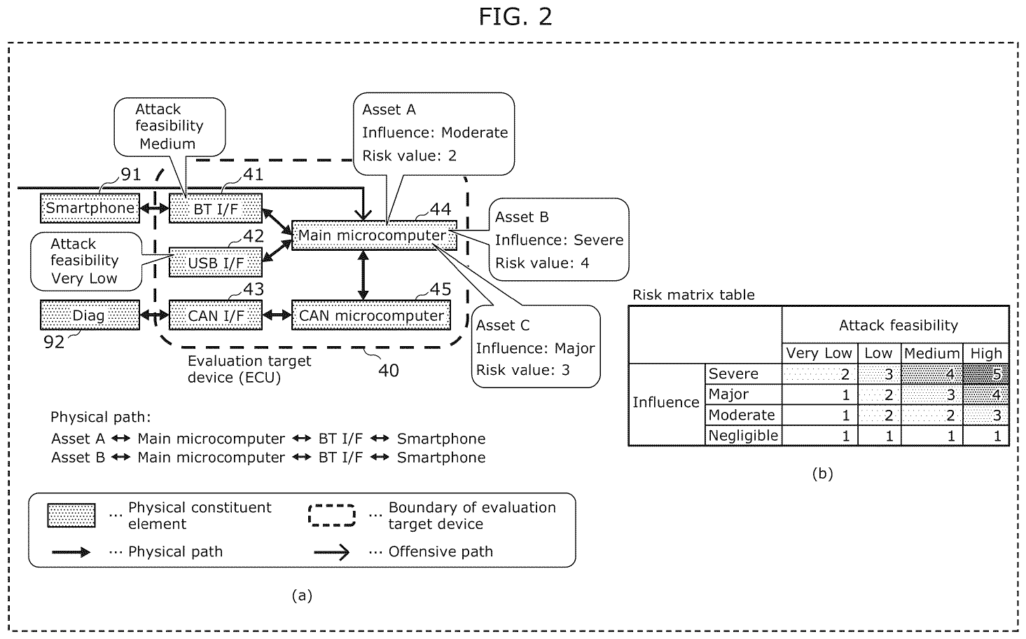

FIG. 2 is a diagram for illustratively describing part of the threat analysis conducted by threat analyzer 21.

For example, threat analyzer 21 may evaluate risk values of assets A, B, and C of evaluation target device 40 as shown in (a) in FIG. 2. Assets A, B, and C may be data or functions of evaluation target device 40 that are to be protected. Note that the functions may be realized by, for example, programs. Evaluation target device 40 may be configured as, for example, an ECU mounted on a vehicle and communicate with external devices such as smartphone 91 and Diag 92 via a wire or wirelessly. Smartphone 91 is a smartphone, and Diag 92 is a device for diagnosing defects as imperfections or malfunctions in a vehicle. Evaluation target device 40 includes physical components including BT interface 41, USB interface 42, CAN interface Main microcomputer 44, and CAN 43, microcomputer 45. BT interface 41 is an interface for Bluetooth (registered trademark) and also labeled BT I/F. USB interface 42 is an interface for a universal serial bus (USB) and also labeled USB I/F. CAN interface 43 is an interface for a controller area network (CAN) and also labeled CAN I/F. Main microcomputer 44 is a microcomputer that controls evaluation target device 40. Main microcomputer 44 includes assets A, B, and C described above. CAN microcomputer 45 is a microcomputer that controls the CAN of evaluation target device 40. Note that the physical components are hardware components.

Here, a physical path exists between each of Main microcomputer 44, BT interface 41, USB interface 42, and CAN microcomputer 45. A physical path also exists between BT interface 41 and smartphone 91. A physical path also exists between CAN microcomputer 45 and CAN interface 43 and between CAN interface 43 and Diag 92. Note that the physical paths are physical connection paths.

Each physical component may have an attack feasibility level assigned thereto. For example, BT interface 41 may have an attack feasibility level of “Medium” assigned thereto. USB interface 42 may have an attack feasibility level of “Very Low” assigned thereto.

Each asset may have an influence level set thereto, the influence level indicating an influence to be exerted on evaluation target device 40 when the asset is attacked. For example, an influence level of “Moderate” is set to asset A, an influence level of “Severe” is set to asset B, and an influence level of “Major” is set to asset C. Note that the influence level may also be referred to as the degree of influence.

Threat analyzer 21 determines an offensive path leading to each of assets A, B, and C. That is, threat analyzer 21 determines a physical path including an array of one or more physical components for each of assets A, B, and C, the physical path being a path from an external device to the asset. In the case where there are a plurality of offensive paths to each asset, threat analyzer 21 determines one offensive path from among the plurality of offensive paths. Note that the offensive path is also referred to as an attack path.

For example, in the case where attacking assets A, B, and C, smartphone 91 may access Main microcomputer 44 via BT interface 41 that has an attack feasibility level of “Medium” assigned thereto. Alternatively, smartphone 91 may access Main microcomputer 44 via USB interface 42 that has an attack feasibility level of “Very Low” assigned thereto. That is, the offensive paths leading to each of assets A, B, and C include an offensive path via BT interface 41 and an offensive path via USB interface 42. In this case, threat analyzer 21 determines an offensive path that passes through a physical component with a highest attack feasibility level assigned thereto. In the case of the aforementioned example, the highest attack feasibility level is “Medium”. Thus, threat analyzer 21 determines, as the offensive path, a physical path that leads from smartphone 91 via BT interface 41 to Main microcomputer 44.

Threat analyzer 21 evaluates the risk value of each asset by deriving the risk value of the asset through use of the attack feasibility level of “Medium” and the influence level of the asset with reference to a risk matrix table shown in (b) in FIG. 2.

As shown in (b) in FIG. 2, the risk matrix table shows the risk value corresponding to each combination of the attack feasibility level and the influence level. The attack feasibility level is classified into Very Low, Low, Medium, and High. These levels are ranked in ascending order. The influence level is classified into Severe, Major, Moderate, and Negligible. These levels are ranked in descending order.

In the aforementioned example, asset A has an influence level of “Moderate”, asset B has an influence level of “Severe”, and asset C has an influence level of “Major”. The attack feasibility levels for the offensive paths leading to these assets are “Medium”. That is, the highest attack feasibility level on the offensive paths, i.e., on the physical paths leading to the assets, is “Medium”. Therefore, threat analyzer 21 derives “2” as a risk value of asset A, “4” as a risk value of asset B, and “3” as a risk value of asset C with reference to the risk matrix table. Then, the risk values of assets A, B, and C are evaluated. Note that the influence level, the attack feasibility level, and the risk matrix table may be defined by, for example, ISO 21434.

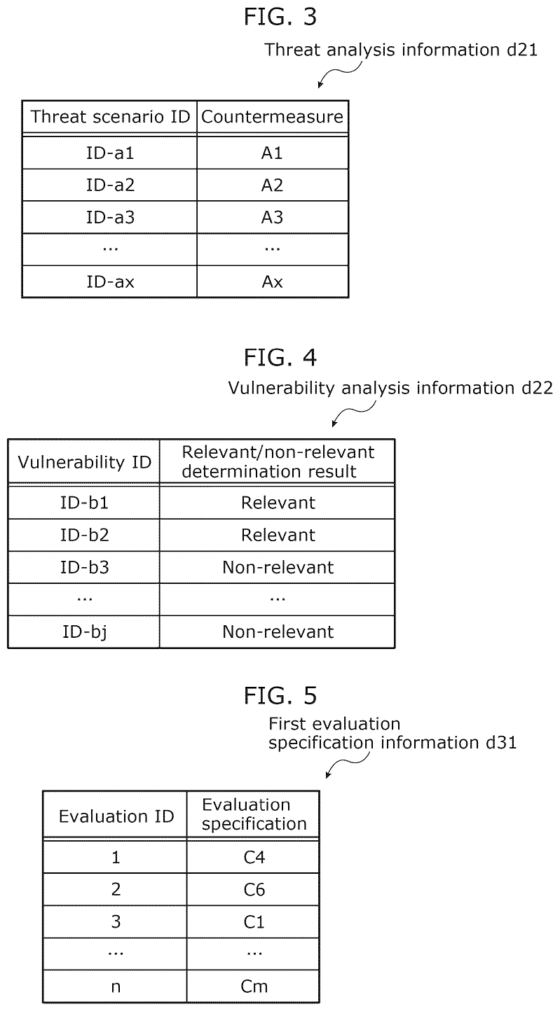

FIG. 3 is a diagram showing one schematic example of threat analysis information d21 generated and output by threat analyzer 21.

As shown in FIG. 3, for example, threat analysis information d21 generated by threat analyzer 21 may indicate each threat scenario ID in association with a countermeasure against a threat identified by the threat scenario ID. The threat scenario ID refers to information for identifying a threat. The threat may, for example, be a threat to an asset such as asset A described above. In one specific example, threat analysis information d21 indicates an threat scenario ID of “ID-a1” with a countermeasure of “A1” against the threat identified by the threat scenario ID of “ID-a1”. Note that threat analysis information d21 may indicate the contents of the threat. The contents of the threat may include information such as the offensive path, the influence level, and the risk value described above.

FIG. 4 is a diagram showing one schematic example of vulnerability analysis information d22 generated and output by vulnerability analyzer 22.

As shown in FIG. 4, for example, vulnerability analysis information d22 generated by vulnerability analyzer 22 may indicate each vulnerability ID in association with a relevant/non-relevant determination result that indicates whether evaluation target device 40 has the vulnerability identified by the vulnerability ID. The vulnerability ID refers to information for identifying vulnerability (i.e., identification information). When evaluation target device 40 has vulnerability, the relevant/non-relevant determination result indicates “Relevant”, and when evaluation target device 40 does not have the vulnerability, the relevant/non-relevant determination result indicates “Non-relevant”. That is, the vulnerability determination result indicates whether evaluation target device 40 has the vulnerability. In one specific example, vulnerability analysis information d22 indicates the vulnerability ID of “ID-b1” with the relevant/non-relevant determination result of “Relevant” for the vulnerability identified by the vulnerability ID of “ID-b1”. Note that vulnerability analysis information d22 may indicate the contents of the vulnerability.

FIG. 5 is a diagram showing one schematic example of first evaluation specification information d31 generated and output by evaluation specification definer 31.

As shown in FIG. 5, for example, first evaluation specification information d31 generated by evaluation specification definer 31 may indicate, for each evaluation ID, an evaluation specification corresponding to the evaluation item identified by the evaluation ID. The evaluation ID refers to information for identifying an evaluation item. In one specific example, first evaluation specification information d31 indicates an evaluation ID of “1” in association with an evaluation specification of “C4” that corresponds to the evaluation item identified by the evaluation ID of “1”.

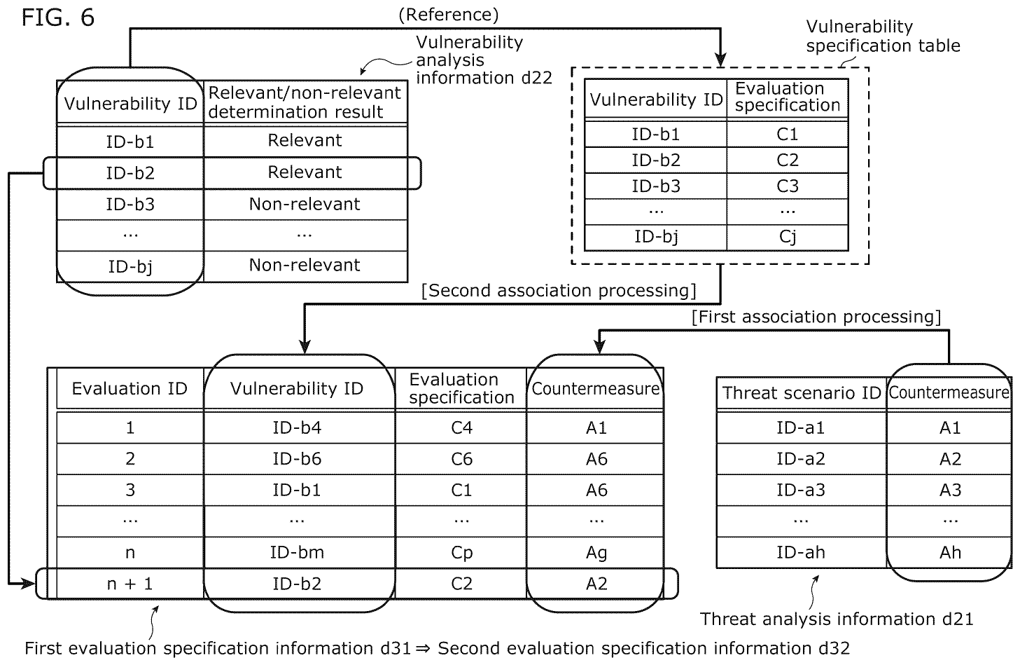

FIG. 6 is a diagram for describing processing operations of evaluation support system 10.

First, threat concatenator 11 of evaluation support system 10 performs the first association processing. Specifically, in the processing, first association threat concatenator 11 concatenates, for each evaluation item of first evaluation specification information d31, information indicating a countermeasure against threats with first evaluation specification information d31 so as to associate the information with the evaluation specification of the evaluation item, the information indicating a result of analysis of the evaluation item and being included in threat analysis information d21.

Through the first association processing, first evaluation specification information d31 that has undergone the first association processing, i.e., second evaluation specification information d13, indicates a countermeasure in association with each evaluation specification. In one specific example, countermeasure “A1” is associated with evaluation specification “C4”, and countermeasure “A6” is associated with evaluation specification “C6”. This association between countermeasures and evaluation specifications may be established by referencing to a table that shows each evaluation specification in association with each countermeasure in advance, or may be established in response to a human input operation.

Next, vulnerability concatenator 12 of evaluation support system 10 performs the second association processing. Specifically, in the second association processing, vulnerability concatenator 12 concatenates, for each evaluation item of first evaluation specification information d31, identification information on the vulnerability corresponding to the evaluation item with first evaluation specification information d31 so as to associate the identification information with the evaluation specification of the evaluation item, the identification information being included in vulnerability analysis information d22. The identification information on the vulnerability refers to the vulnerability ID.

Specifically, vulnerability concatenator 12 only concatenates each vulnerability ID associated with a determination result indicating “Relevant” in vulnerability analysis information d22 with first evaluation specification information d31. At this time, vulnerability concatenator 12 references to a vulnerability specification table. The vulnerability specification table indicates, for each vulnerability ID, an evaluation specification for evaluating vulnerability identified by the vulnerability ID. That is, vulnerability concatenator 12 retrieves each vulnerability ID associated with the determination result indicating “Relevant” in vulnerability analysis information d22 from the vulnerability specification table and identifies an evaluation specification associated with the vulnerability ID with reference the vulnerability specification table. Then, vulnerability concatenator 12 retrieves the identified evaluation specification from first evaluation specification information d31 and associates the aforementioned vulnerability ID with the retrieved evaluation specification. For example, vulnerability concatenator 12 concatenates vulnerability ID “ID-b1” associated with the determination result indicating “Relevant” in vulnerability analysis information d22 with first evaluation specification information d31. At this time, vulnerability concatenator 12 retrieves vulnerability ID “ID-b1” from the vulnerability specification table and identifies evaluation specification “C1” for evaluating the vulnerability identified by vulnerability ID “ID-b1”. Then, vulnerability concatenator 12 retrieves identified evaluation specification “C1” from first evaluation specification information d31 and associates vulnerability ID “ID-b1” with retrieved evaluation specification “C1”.

Next, re-definer 13 of evaluation support system 10 re-defines one or more evaluation specifications indicated by first evaluation specification information d31. For example, vulnerability analysis information d22 may in some case include identification information on vulnerability (i.e., vulnerability ID) corresponding to a missing evaluation specification that is an evaluation specification not indicated by first evaluation specification information d31. In this case, re-definer 13 re-defines one or more evaluation specifications indicated by first evaluation specification information d31 by adding the missing evaluation specification and the vulnerability ID corresponding to the missing evaluation specification to first evaluation specification information d31 that has undergone the first association processing and the second association processing.

In one specific example, vulnerability analysis information d22 shows vulnerability ID “ID-b2” in association with the determination result indicating “Relevant”. In the vulnerability specification table, vulnerability ID “ID-b2” is associated with evaluation specification “C2”. However, first evaluation specification information d31 shown in FIG. 5 does not include evaluation specification “C2”. Thus, evaluation specification “C2” corresponds to the aforementioned missing evaluation specification. Therefore, re-definer 13 adds evaluation specification “C2” as the missing evaluation specification and vulnerability ID “ID-b2” to evaluation corresponding specification “C2” to first evaluation specification information d31. At this time, re-definer 13 associates new evaluation ID “n+1” with vulnerability ID “ID-b2” and evaluation specification “C2” and further associates countermeasure “A2” indicated by threat analysis information d21 with evaluation specification “C2”.

Alternatively, re-definer 13 may establish the aforementioned re-definition by changing each evaluation specification indicated by first evaluation specification information d31 that has undergone the first association processing and the second association processing, in accordance with the vulnerability ID and the countermeasure against threats associated with the evaluation specification. This change to the evaluation specification may be implemented by referencing to a table that shows evaluation specifications in association with vulnerability IDs and countermeasures against threats. In the case of changing evaluation specifications, for example, the evaluation specifications associated with vulnerability IDs and countermeasures against threats in first evaluation specification information d31 may be replaced by evaluation specifications associated with vulnerability IDs and countermeasures against threats in the table.

Through the first association processing, the second association processing, and the re-definition described above, first evaluation specification information d31 is updated to second evaluation specification information d13. Then, re-definer 13 stores second evaluation specification information d13 in evaluation database 14 and outputs second evaluation specification information d13 to evaluation device 32. In accordance with second evaluation specification information d13, evaluation device 32 evaluates evaluation target device 40 and generates and outputs result information d32 indicating the result of the evaluation to result determiner 33. Result determiner 33 acquires result information d32, determines the result of the evaluation indicated by result information d32, and generates determination information d33 indicating the result of the determination Then, result determiner 33 generates evaluated specification information d14 by combining determination information d33 with second evaluation specification information d13 stored in evaluation database 14.

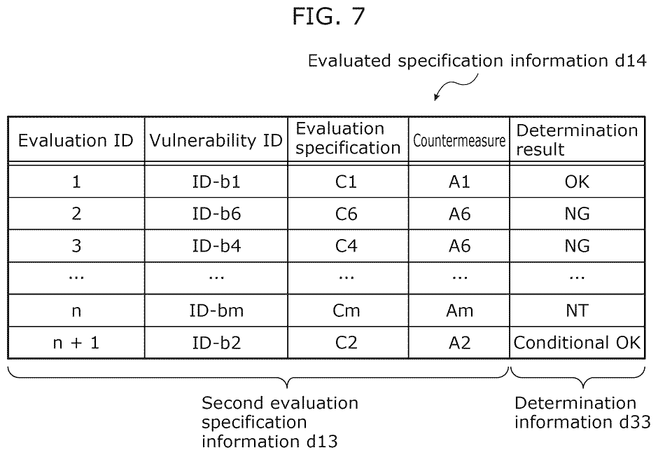

FIG. 7 is a diagram showing one example of evaluated specification information d14.

Evaluated specification information d14 includes second evaluation specification information d13 and determination information d33. Specifically, evaluated specification information d14 indicates, for each evaluation ID indicated by second evaluation specification information d13, the result of determining the result of evaluation of the evaluation item identified by the evaluation ID. The determination result is indicated as, for example, OK, NG, NT, and Conditional OK. In the case where the evaluation result is represented by a numerical value, for example if the numerical value is greater than or equal to a threshold value, result determiner 33 may write OK as the result of determination of the evaluation result on determination information d33 included in evaluated specification information d14. Or, if the evaluation result is as expected, result determiner 33 may write OK on determination information d33. On the other hand, for example if the numerical value is less than the threshold value, result determiner 33 may write NG as the result of the determination of the evaluation result on determination information d33 included in evaluated specification information d14. Or, if the evaluation result is not as expected, result determiner 33 may write NG on determination information d33. Note that NT indicates that the evaluation is not applicable. Conditional OK indicates that, if a predetermined condition is satisfied, the evaluation result is treated as OK. Alternatively, Conditional OK may indicate that the evaluation result has a problem in terms of security, but is correct as a result of the specification.

Evaluated specification information d14 is stored in evaluation database 14 and fed back to threat analyzer 21 and vulnerability analyzer 22. The feedback of evaluated specification information d14 may be realized by threat analyzer 21 and vulnerability analyzer 22 accessing evaluation database 14 and acquiring evaluated specification information d14. Alternatively, the feedback of evaluated specification information d14 may be realized by a processing circuit included in evaluation database 14 actively transmitting evaluated specification information d14 to threat analyzer 21 and vulnerability analyzer 22.

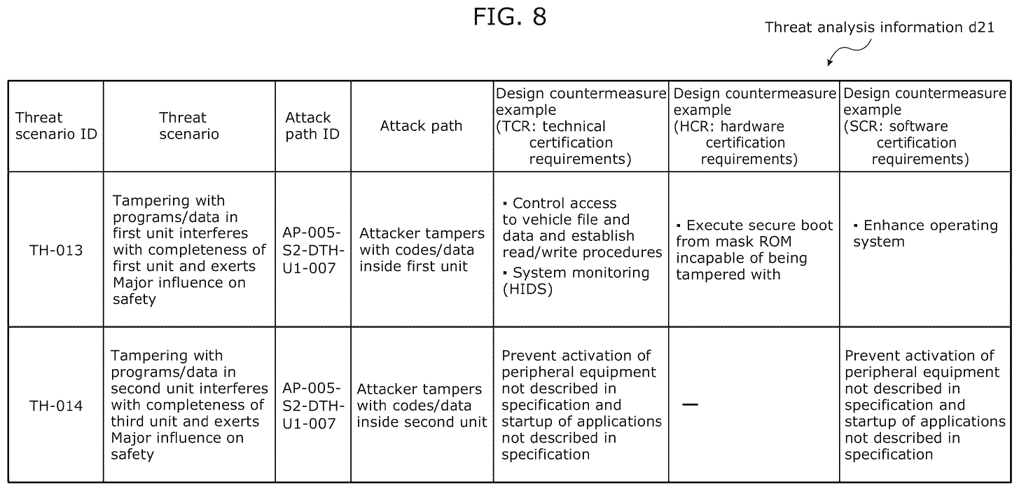

FIG. 8 is a diagram showing one specific example of threat analysis information d21.

Threat analysis information d21 includes the threat scenario ID, a threat scenario, an attack path ID, an attack path, and design countermeasure examples. In the example shown in FIG. 8, as one example of the threat scenario, threat analysis information d21 indicates that tampering with programs/data in a first unit exerts Major influence on safety. The programs/data may be one example of an asset. The offensive path may be the aforementioned offensive path. The design countermeasure examples show countermeasures against threats and include technical certification requirements (TCR) that are countermeasures required in terms of technology, hardware certification requirements (HCR) that are countermeasures required in terms of hardware, and software certification requirements (SCR) that are countermeasures required in terms of software.

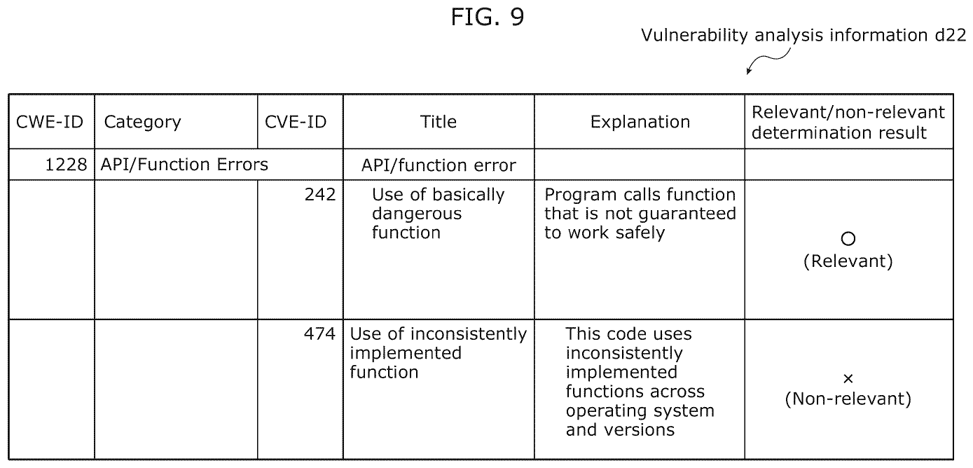

FIG. 9 is a diagram showing one specific example of vulnerability analysis information d22.

Vulnerability analysis information d22 includes a common weakness enumeration-ID (CWE-ID), a category, a common vulnerabilities and exposures-ID (CVE-ID), a title, an explanation, and a relevant/non-relevant determination result. The CWE-ID refers to information for identifying the category of vulnerability. The CVE-ID refers to information for identifying vulnerability and corresponds to the vulnerability ID. The title refers to the subject of vulnerability, and the explanation refers to an explanation of vulnerability.

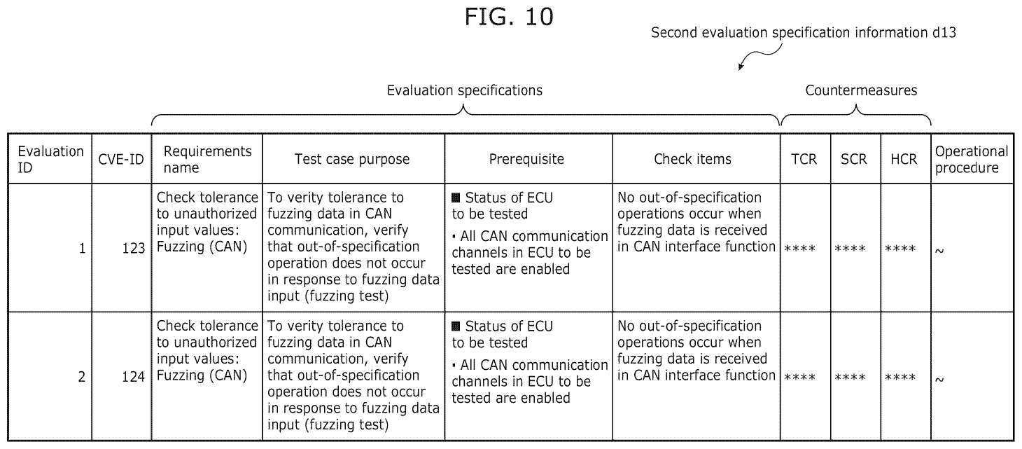

FIG. 10 is a diagram showing one specific example of second evaluation specification information d13.

Second evaluation specification information d13 includes the evaluation ID, the CVE-ID, a requirements name, a test case purpose, a prerequisite, check items, TCR, SCR, HCR, and an operational procedure. For example, the evaluation specification may be configured by the requirements name, the test case purpose, the prerequisites, and the check items, and the countermeasure is configured by TCR, SCR, and HCR. The requirements name refers to the name of the evaluation item, and the test case purpose is the purpose of evaluation. The prerequisite refers to a condition serving as a precondition for evaluation, and the check items refer to items to be checked for evaluation. The operational procedure refers to a procedure of evaluation.

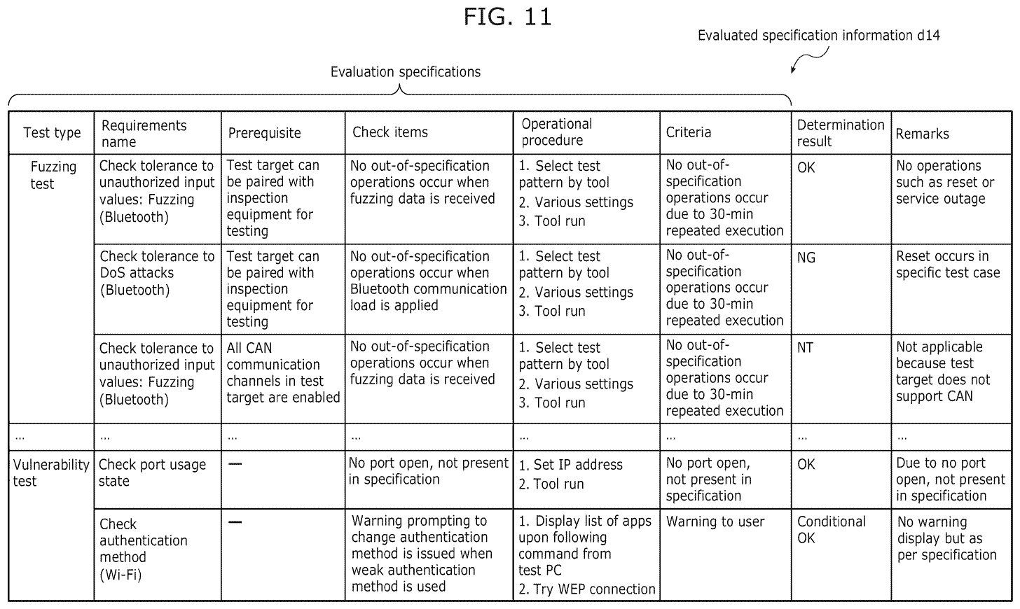

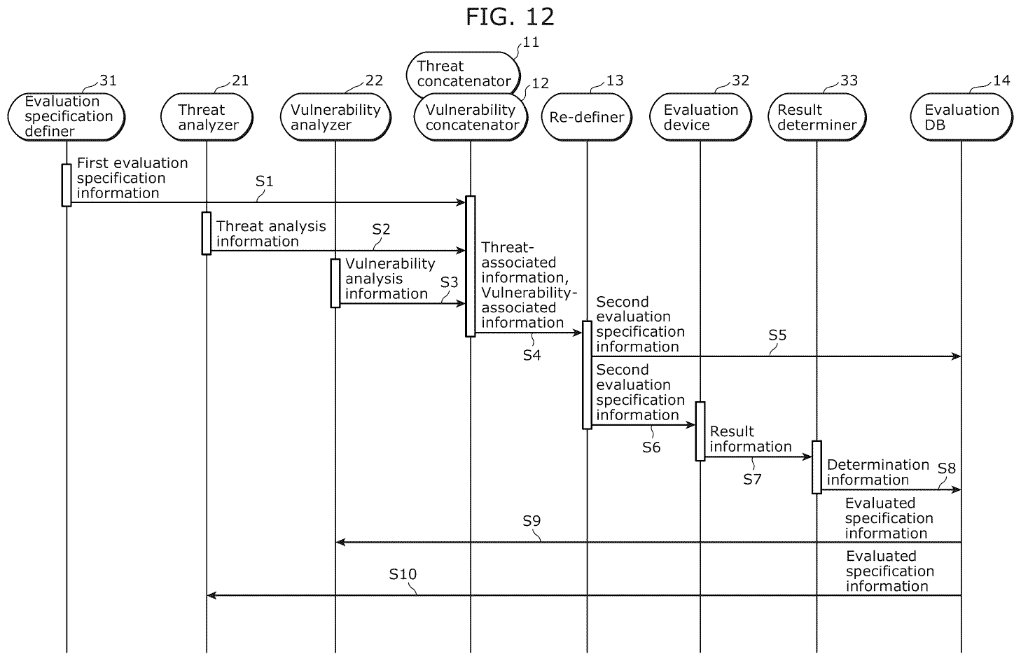

FIG. 11 is a diagram showing one specific example of part of evaluated specification information d14.

Evaluated specification information d14 includes the evaluation specification, the determination result, and remarks. In the example shown in FIG. 11, the evaluation ID, the vulnerability ID, and the countermeasure are omitted in order to specifically show the evaluation specification.

The evaluation specification includes a test type, a requirements name, a prerequisite, a check item, an operational procedure, and criteria. Note that the evaluation specification may further include the purpose of evaluation. The test type refers to the type of evaluation. Examples of the test type include a fuzzing test and a vulnerability test. The fuzzing test is a test for finding unknown vulnerability in response to invalid data input. For example, approximately 100 evaluation items are included in the fuzzing test. These evaluation items may be classified into categories such as Bluetooth, Bluetooth Low Energy (BLE), CAN, Transmission Control Protocol/Internet Protocol (TCP/IP), Denial of Service (Dos) attack, etc. The vulnerability test is a test for finding known vulnerability of, for example, a network or a platform. For example, approximately 120 evaluation items are included in the vulnerability test. These evaluation items may be classified in categories such as network communication analysis, on-vehicle network (e.g., CAN) analysis, binary analysis, application analysis, and platform analysis. The criteria may correspond to, for example, the aforementioned check items and indicate, for example, a condition, a reference, and a threshold value for use in determination by determination processor 34. If the evaluation result satisfies these conditions, evaluated specification information d14 shows the determination result indicating OK.

Evaluated specification information d14 is fed back to threat analyzer 21 and vulnerability analyzer 22. When having acquired evaluated specification information d14 as feedback, threat analyzer 21 revamps the countermeasure in accordance with the determination result indicated by evaluated specification information d14. For example, threat analyzer 21 revamps each countermeasure corresponding to the determination result indicating “NG”. In the case where a risk value is derived for each of a plurality of threats corresponding to the determination result indicating “NG”, threat analyzer 21 may prioritize the revamp of the countermeasure for each of the threats by using the aforementioned risk values. That is, the use of the risk values allows threat analyzer 21 to set priorities for the revamp of a plurality of countermeasures, i.e., to weigh the revamp of a plurality of countermeasures. For example, in the case of the occurrence of an incident, analysis will be conducted according to the set priorities. Meanwhile, for each countermeasure corresponding to the determination result indicating “OK”, threat analyzer 21 can assure the effectiveness of the countermeasure. When evaluated specification information d14 has been acquired as feedback, vulnerability analyzer 22 may also revamp, like threat analyzer 21, vulnerability analysis in accordance with the determination result indicated by evaluated specification information d14. For example, vulnerability analyzer 22 may revamp the relevant/non-relevant determination result indicating whether vulnerability is relevant to evaluation target device 40. Alternatively, vulnerability analyzer 22 may assure the effectiveness of the relevant/non-relevant determination result. In this way, the efficiency of analysis can be improved based on evaluated specification information d14.

FIG. 12 is a sequence diagram showing one example of processing operations of development system 100.

Evaluation specification definer 31 generates first evaluation specification information d31 and outputs the generated information to threat concatenator 11 and vulnerability concatenator 12 (step S1). Threat analyzer 21 generates threat analysis information d21 and outputs the generated information to threat concatenator 11 (step S2). Vulnerability analyzer 22 generates vulnerability analysis information d22 and outputs the generated information to vulnerability concatenator 12 (step S3). Threat concatenator 11 generates threat-associated information d11 in accordance with first evaluation specification information d31 and threat analysis information d21 and outputs the generated information to re-definer 13. Furthermore, vulnerability concatenator 12 generates vulnerability-associated information d12 in accordance with first evaluation specification information d31 and vulnerability analysis information d22 and outputs the generated information to re-definer 13 (step S4).

Re-definer 13 generates second evaluation specification information d13 based on threat-associated information d11 and vulnerability-associated information d12 and outputs the generated information to evaluation database 14 (step S5), and further outputs second evaluation specification information d13 to evaluation device 32 (step S6).

Evaluation device 32 evaluates evaluation target device 40 in accordance with second evaluation specification information d13, generates result information d32 indicating the result of the evaluation, and outputs the generated information to result determiner 33 (step S7). Result determiner 33 determines, on the basis of the aforementioned criteria and any other information, whether the evaluation result indicated by result information d32 is OK or NG, and stores determination information d33 indicating the result of the determination in evaluation database 14 (step S8). In this way, evaluated specification information d14 including second evaluation specification information d13 and determination information d33 is generated and stored in evaluation database 14.

Evaluated specification information d14 is fed back from evaluation database 14 to threat analyzer 21 and vulnerability analyzer 22 (steps S9 and S10).

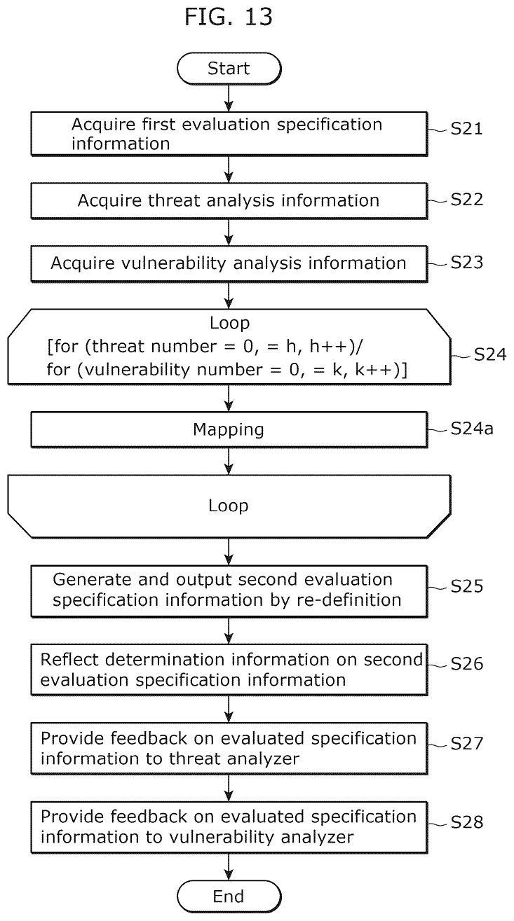

FIG. 13 is a flowchart showing one example of processing operations of evaluation support system 10.

First, each of threat concatenator 11 and vulnerability concatenator 12 acquires first evaluation specification information d31 from evaluation specification definer 31 (step S21). Then, threat concatenator 11 acquires threat analysis information d21 from threat analyzer 21 (step S22), and vulnerability concatenator 12 acquires vulnerability analysis information d22 from vulnerability analyzer 22 (step S23).

Next, threat concatenator 11 and vulnerability concatenator 12 execute loop processing (step S24). In this loop processing, threat concatenator 11 performs processing for finding a countermeasure corresponding to a threat number from threat analysis information d21 and concatenating the found countermeasure with an evaluation specification corresponding to the countermeasure in first evaluation specification information d31, i.e., performs mapping of countermeasures (step S24a). The threat number refers to the number assigned to each threat ID included in threat analysis information d21. For example, different integral numbers ranging from 0 to h (where h is an integral number greater than or equal to 1) are assigned as threat numbers to the threat IDs included in threat analysis information d21. Then, in step S24, threat concatenator 11 repeatedly executes mapping (step S24a) of the threat numbers while incrementing the threat numbers by 1 in the range of 0 to h.

Similarly, in the loop processing, vulnerability concatenator 12 finds a vulnerability ID corresponding to the vulnerability number from vulnerability analysis information d22 and performs the processing for concatenating the vulnerability ID with the evaluation specification corresponding to the vulnerability ID indicated by first evaluation specification information d3, i.e., performs mapping of the vulnerability ID (step S24a). Note that the mapping is skipped if first evaluation specification information d31 does not include any evaluation specification corresponding to the vulnerability ID. The vulnerability number refers to the number assigned to each vulnerability ID associated with the relevant/non-relevant determination result indicating “Relevant” among all the vulnerability IDs included in vulnerability analysis information d22. For example, each vulnerability ID included in vulnerability analysis information d22 is assigned a different integral number ranging from 0 to k (where k is an integral number greater than or equal to 1) as the vulnerability number. Then, in step S24, vulnerability concatenator 12 repeatedly executes mapping for the vulnerability number (step S24a) while incrementing the vulnerability number from 0 to k.

Next, re-definer 13 generates and outputs second evaluation specification information d13 by re-defining one or more evaluation specifications included in first evaluation specification information d31 that has undergone the loop processing in step S24 (step S25). That is, re-definer 13 generates second evaluation specification information d13 by adding each vulnerability ID for which mapping is skipped and the evaluation specification corresponding to the vulnerability ID (i.e., missing evaluation specification) to first evaluation specification information d31 that has undergone the loop processing. Second evaluation specification information d13 is output to evaluation device 32, used for evaluation by evaluation target device 40, and further stored in evaluation database 14. Then, the result of the evaluation of evaluation target device 40 is determined by result determiner 33. In this way, determination information d33 indicating the determination result is stored in evaluation database 14 by result determiner 33.

As a result of the storage of determination information d33 by result determiner 33, second evaluation specification information d13 that reflects determination information d33 is stored as evaluated specification information d14 in evaluation database 14 (step S26). Then, evaluation database 14 (i.e., the feedback device) feeds back evaluated specification information d14 to threat analyzer 21 (step S27) and further feeds back evaluated specification information d14 to vulnerability analyzer 22 (step S28).

As described above, in evaluation support system 10 according to the present embodiment, one or more evaluation specifications included in second evaluation specification information d13 are associated with threat analysis information d21 and vulnerability analysis information d22 through the first association processing, the second association processing, and the re-definition. That is, the security evaluation, the threat analysis, and the vulnerability analysis performed by evaluation target device 40 have not conventionally been associated with one another, but the present embodiment enables the association of them. As a result, it becomes more likely that evaluation target device 40 can be evaluated exhaustively while avoiding omissions of necessary evaluations. That is, it is possible to reduce the possibility of in complete security evaluations of evaluation target device 40. This allows effective support of the evaluation of evaluation target device 40.

According to the present embodiment, through the first association processing, the countermeasures against threats are associated with the evaluation specifications. Thus, the associated countermeasures can be referenced to for the evaluation conducted in accordance with first evaluation specification information d31 that has undergone the first association processing. This allows more effective support of the evaluation of evaluation target device 40.

According to the present embodiment, through the second association processing, the identification information on vulnerability is associated with the evaluation specifications. Thus, the associated vulnerability can be referenced to for the evaluation conducted in accordance with second evaluation specification information d13 that has undergone the second association processing. This allows more effective support of the evaluation of evaluation target device 40.

According to the present embodiment, through the re-definition, first evaluation specification information d31 is updated to second evaluation specification information d13 that includes the missing evaluation specifications and the identification information on vulnerability. This allows evaluation target device 40 to be evaluated exhaustively while avoiding omissions of necessary evaluations.

According to the present embodiment, evaluated specification information d14 is fed back to threat analyzer 21 and vulnerability analyzer 22. Thus, if evaluated specification information d14 indicates a good evaluation result (e.g., OK) for an evaluation specification, evaluation specification threat analyzer 21 can assure the result of analysis of a threat. For example, if the analysis result indicates a countermeasure against threats, threat analyzer 21 can assure the effectiveness of the countermeasure. On the other hand, if evaluated specification information d14 indicates a bad evaluation result (e.g., NG) for an evaluation specification, threat analyzer 21 can improve the threat analysis. For example, if the analysis result indicates a countermeasure against threats, threat analyzer 21 can improve the countermeasure. As a result, the accuracy of planning the countermeasure is improved. Vulnerability analyzer 22 can improve the accuracy of the vulnerability analysis in accordance with the evaluation result indicated by evaluated specification information d14. That is, the present embodiment allows not only one-way processing from the threat analysis and the vulnerability analysis to the evaluation, but also the feedback of the evaluation result to the threat analysis and the vulnerability analysis. This allows effective risk management of evaluation target device 40.

### Embodiment 2

Embodiment 2 is different from Embodiment 1 in that only threat analysis information d21 is used out of threat analysis information d21 and vulnerability analysis information d22. Hereinafter, only differences of Embodiment 2 from Embodiment 1 are described.

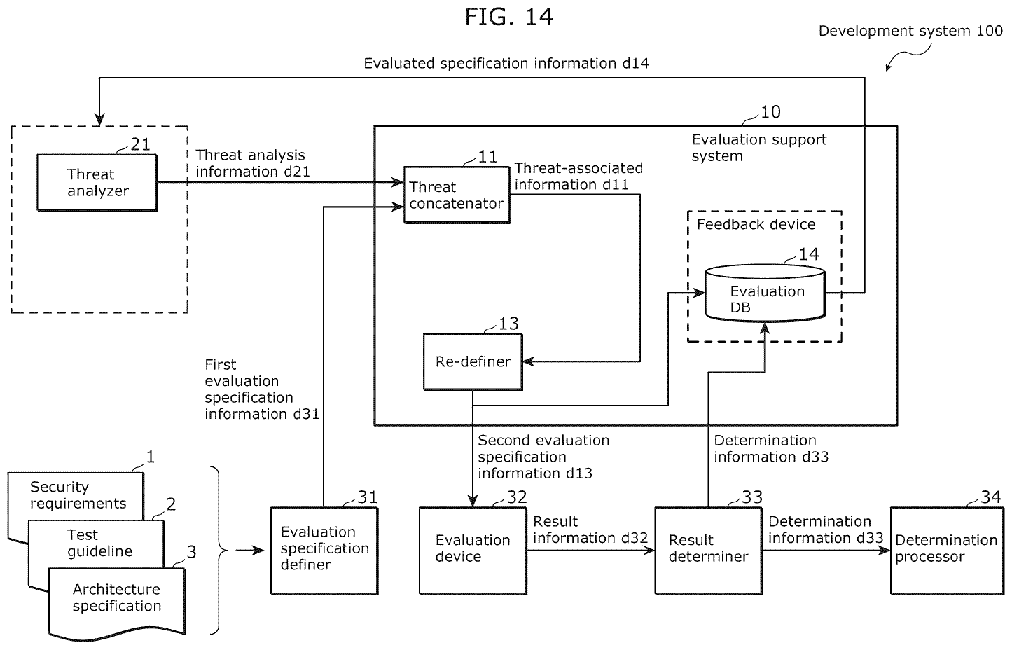

FIG. 14 is a diagram showing one example of a configuration of development system 100 according to Embodiment 2.

Development system 100 according to Embodiment 2 includes threat analyzer 21, evaluation specification definer 31, evaluation device 32, result determiner 33, determination processor 34, and evaluation support system 10.

Threat analyzer 21, evaluation specification definer 31, evaluation device 32, result determiner 33, and determination processor 34 have no differences from those described in Embodiment 1.

Evaluation support system 10 includes threat concatenator 11, re-definer 13, and evaluation database (also referred to as evaluation DB) 14. Threat concatenator 11 has no differences from that described in Embodiment 1.

Re-definer 13 generates and outputs second evaluation specification information d13 by re-defining one or more evaluation specifications indicated by first evaluation specification information d31 through the first association processing. That is, re-definer 13 acquires threat-associated information d11 from threat concatenator 11 and generates second evaluation specification information d13 based on threat-associated information d11. Then, re-definer 13 outputs second evaluation specification information d13 to evaluation device 32 and stores second evaluation specification information d13 in evaluation database 14. Re-definer 13 may establish the aforementioned re-definition by changing the evaluation specification(s) indicated by first evaluation specification information d31 that has undergone the first association processing, in accordance with the countermeasure(s) against threats associated with the evaluation specification(s). This change to the evaluation specification(s) may be implemented by referencing to a table that shows evaluation specifications in association with countermeasures against threats. In the case of changing the evaluation specification(s), for example, the evaluation specification(s) associated with the countermeasure(s) against threats in first evaluation specification information d31 may be replaced by the evaluation specification(s) associated with the countermeasure(s) against threats in the table.

Re-definer 13 of evaluation support system 10 also re-defines one or more evaluation specifications indicated by first evaluation specification information d31. For example, threat analysis information d21 may in some cases include information (i.e., threat ID) indicating a countermeasure against threats that corresponds to a missing evaluation specification that is an evaluation specification not indicated by first evaluation specification information d31. In this case, re-definer 13 re-defines one or more evaluation specifications indicated by first evaluation specification information d31 by adding the missing evaluation specification and the threat ID corresponding to the missing evaluation specification to first evaluation specification information d31 that has undergone the first association processing.

Evaluation database 14 stores evaluated specification information d14. Evaluated specification information d14 stored in evaluation database 14 is fed back to threat analyzer 21. That is, evaluation database 14 according to the present embodiment is configured as a feedback device that feeds back second evaluation specification information d13 as evaluated specification information d14 to threat analyzer 21, the second evaluation specification information indicating the result of the evaluation of the evaluation target device obtained by the evaluation conducted in accordance with second evaluation specification information d13.

FIG. 12 is a sequence diagram showing one example of the processing operations of development system 100.

Evaluation specification definer 31 generates first evaluation specification information d31 and outputs the generated information to threat concatenator 11 (step S1). Threat analyzer 21 generates threat analysis information d21 and outputs the generated information to threat concatenator 11 (step S2). Threat concatenator 11 generates threat-associated information d11 based on first evaluation specification information d31 and threat analysis information d21 and outputs the generated information to re-definer 13 (step S4).

Re-definer 13 generates second evaluation specification information d13 based on threat-associated information d11 and outputs the generated information to evaluation database 14 (step S5), and further outputs second evaluation specification information d13 to evaluation device 32 (step S6).

Re-definer 13 and result determiner 33 have no differences from those described in Embodiment 1.

Evaluated specification information d14 generated and stored in evaluation database 14 is fed back from evaluation database 14 to threat analyzer 21 (step S10).

FIG. 13 is a flowchart showing one example of processing operations of evaluation support system 10.

First, threat concatenator 11 acquires first evaluation specification information d31 from evaluation specification definer 31 (step S21). Then, threat concatenator 11 acquires threat analysis information d21 from threat analyzer 21 (step S22).

Threat concatenator 11, re-definer 13, and result determiner 33 have no differences from those described in Embodiment 1.

As a result of the storage of determination information d33 by result determiner 33, second evaluation specification information d13 that reflects determination information d33 is stored as evaluated specification information d14 in evaluation database 14 (step S26). Then, evaluation database 14 (i.e., feedback device) provides feedback of evaluated specification information d14 to threat analyzer 21 (step S27).

In evaluation support system 10 according to Embodiment 2, one or more evaluation specifications included in second evaluation specification information d13 are associated with threat analysis information d21 through the first association processing and the re-definition. That is, the security evaluation and the threat analysis performed by evaluation target device 40 have not conventionally been associated with each other, but the present embodiment enables the association of them. As a result, it becomes more likely that evaluation target device 40 can be evaluated exhaustively while avoiding omissions of necessary evaluations. That is, it is possible to reduce the possibility of incomplete security evaluations of evaluation target device 40. This allows effective support of the evaluation of evaluation target device 40.

### Embodiment 3

Embodiment 3 is different from Embodiment 1 in that only vulnerability analysis information d22 is used out of threat analysis information d21 and vulnerability analysis information d22. Hereinafter, only differences of Embodiment 3 from Embodiment 1 are described.

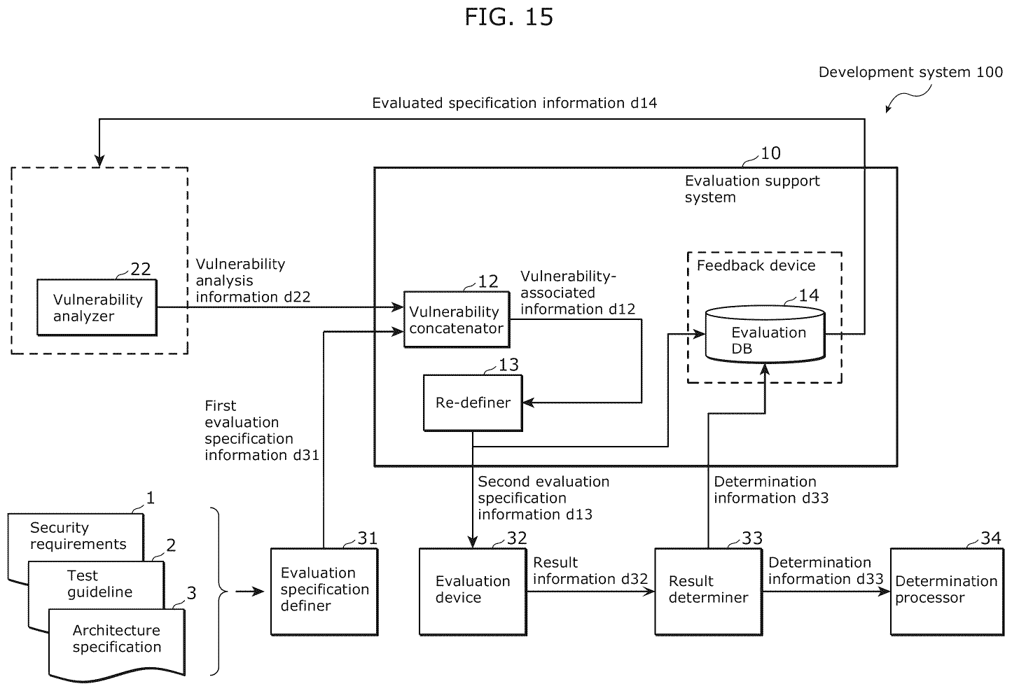

FIG. 15 is a diagram showing one example of a configuration of development system 100 according to Embodiment 3

Development system 100 according to Embodiment 3 includes vulnerability analyzer 22, evaluation specification definer 31, evaluation device 32, result determiner 33, determination processor 34, and evaluation support system 10.

Vulnerability analyzer 22, evaluation specification definer 31, evaluation device 32, result determiner 33, and determination processor 34 have no differences from those described in Embodiment 1.

Evaluation support system 10 includes vulnerability concatenator 12, re-definer 13, and evaluation database (also referred to as evaluation DB) 14.

Vulnerability concatenator 12 has no differences from that described in Embodiment 1.

Re-definer 13 generates and outputs second evaluation specification information d13 by re-defining one or more evaluation specifications by indicated first evaluation specification information d31 through the second association That is, re-definer 13 acquires vulnerability-processing associated information d12 from vulnerability concatenator 12 and generates second evaluation specification information d13 based on vulnerability-associated information d12. Then, re-definer 13 outputs second evaluation specification information d13 to evaluation device 32 and stores second evaluation specification information d13 in evaluation database 14. Re-definer 13 may establish the aforementioned re-definition by changing the evaluation specification(s) indicated by first evaluation specification information d31 that has undergone second association processing while changing the evaluation specification(s), in accordance with the vulnerability ID(s) associated with the evaluation specification(s). This change to the evaluation specification(s) may be realized by referencing to a table that shows evaluation specifications in association with vulnerability IDs. In the case of changing the evaluation specifications(s), for example, the evaluation specification(s) indicated in association with the vulnerability ID(s) in first evaluation specification information d31 may be replaced by the evaluation specification(s) indicated in association with the vulnerability ID(s) in the table.

Evaluation database 14 stores evaluated specification information d14. Evaluated specification information d14 stored in evaluation database 14 is fed back to vulnerability analyzer 22. That is, evaluation database 14 according to the present embodiment is configured as a feedback device that feeds back second evaluation specification information d13 as evaluated specification information d14 to vulnerability analyzer 22, the second evaluation specification information indicating the result of the evaluation of the evaluation target device obtained by the evaluation conducted in accordance with second evaluation specification information d13.

FIG. 12 is a sequence diagram showing one example of the processing operations of development system 100.

Evaluation specification definer 31 generates first evaluation specification information d31 and outputs the generated information to vulnerability concatenator 12 (step S1). Vulnerability analyzer 22 generates vulnerability analysis information d22 and outputs the generated information to vulnerability concatenator 12 (step S3). Vulnerability concatenator 12 generates vulnerability-associated information d12 based on first evaluation specification information d31 and vulnerability analysis information d22 and outputs the generated information to re-definer 13 (step S4).

Re-definer 13 generates second evaluation specification information d13 based on vulnerability-associated information d12 and outputs the generated information to evaluation database 14 (step S5), and further outputs second evaluation specification information d13 to evaluation device 32 (step S6).

Re-definer 13 and result determiner 33 have no differences from those described in Embodiment 1.

Evaluated specification information d14 generated and stored in evaluation database 14 is fed back from evaluation database 14 to vulnerability analyzer 22 (step S9).

FIG. 13 is a flowchart showing one example of the processing operations of evaluation support system 10.

First, vulnerability concatenator 12 acquires first evaluation specification information d31 from evaluation specification definer 31 (step S21). Then, vulnerability concatenator 12 acquires vulnerability analysis information d22 from vulnerability analyzer 22 (step S23).

Vulnerability concatenator 12, re-definer 13, and result determiner 33 have no differences from those described in Embodiment 1.

As a result of the storage of determination information d33 by result determiner 33, evaluation database 14 stores second evaluation specification information d13 that reflects determination information d33 as evaluated specification information d14 (step S26). Then, evaluation database 14 (i.e., feedback device) feeds back evaluated specification information d14 to vulnerability analyzer 22 (step S28).

In evaluation support system 10 according to Embodiment 3, one or more evaluation specifications included in second evaluation specification information d13 are associated with vulnerability analysis information d22 through the second association processing and the re-definition. That is, the security evaluation and the vulnerability analysis performed by evaluation target device 40 have not conventionally been associated with each other, but the present embodiment allows the association of them. As a result, it becomes more likely that evaluation target device 40 can be evaluated exhaustively while avoiding omissions of necessary evaluations. That is, it is possible to reduce the possibility of incomplete security evaluations of evaluation target device 40. This allows effective support of the evaluation of evaluation target device 40.

While evaluation support system 10 and the evaluation support method according to one or a plurality of aspects of the present disclosure have been described thus far with reference to each embodiment, the present disclosure is not intended to be limited to these embodiments. Any of other various modifications conceivable by those skilled in the art may also be made to each embodiment described above without departing from the scope of the present disclosure.

For example, although evaluation target device 40 according to the embodiments described above is an ECU, it may be any other equipment as long as serving as a device for performing information processing.

In the embodiments described above, evaluation database 14 stores evaluated specification information d14 and feeds back evaluated specification information d14. Here, a new countermeasure plan for an evaluation item corresponding the determination result (specifically, NG) included in evaluated specification information d14 may be further stored in evaluation database 14 and provided as feedback. The new countermeasure plan may be stored in response to a human input operation.

Evaluated specification information d14 and so on may be fed back not only to threat analyzer 21 and vulnerability analyzer 22 but also to any other constituent element. The other constituent elements may, for example, be a security executor and a cyber security (CS)-compliant device. The security executor may perform processing such as software program coding of evaluation target device 40, the processing being the most downstream processing executed in a V process for automobile development.

Although evaluation support system 10 according to the embodiments described above includes neither evaluation device 32 nor result determiner 33, these constituent elements may be included in evaluation support system 10.

In the embodiments described above, each constituent element included in evaluation support system 10 may perform processing that corresponds to the constituent element in response to a human input operation, or may automatically perform the processing without receiving any human input operation. In the same manner as described above, each constituent element included in development system 100 may also perform processing corresponding to the constituent element in response to a human input operation, or may automatically perform the processing without receiving any human input operation. Such processing that is automatically performed may use a machine learning model or the like that indicates a correlation between input and output.

In the embodiments described above, each constituent element may be configured as dedicated hardware, or may be realized by executing a software program suitable for the constituent element. Each constituent element may also be realized by a program executor such as a central processing unit (CPU) or a processor reading out and executing a software program recorded on a recording medium such as a hard disk or semiconductor memory. Here, software that realizes the evaluation support systems or the like according to the embodiments described above is a computer program for causing a computer to execute each step in the flowchart shown in FIG. 13.

Note that the following cases are also included in the present disclosure.

(1) The at least one system or device described above may specifically be a computer system configured by, for example, a microprocessor, ROM, RAM, a hard disk unit, a display unit, a keyboard, and a mouse. The RAM or hard disk unit stores computer programs. At least one of the devices described above achieves its function as a result of the microprocessor operating in accordance with the computer programs. The computer programs as used herein are configured by a combination of a plurality of instruction codes that indicate commands given to the computer in order to achieve predetermined functions.

(2) Some or all of the constituent elements that configure at least one system or device described above may be configured as single system large-scale integration (LSI). The system LSI is ultra-multifunctional LSI manufactured by integrating a plurality of components on a single chip and is specifically a computer system that may include, for example, a microprocessor, ROM, and RAM. The RAM stores computer programs. The system LSI achieves its function as a result of the microprocessor operating in accordance with the computer programs.

(3) Some or all of the constituent elements that configure at least one system or device described above may be configured as an IC card or a stand-alone module that is detachable from the device. The IC card or the module may be a computer system configured by, for example, a microprocessor, ROM, and RAM. The IC card or the module may include the above-described ultra-multifunctional LSI. The IC card or the module achieves its function as a result of the microprocessor operating in accordance with the computer programs. The IC card or the module may have protection against tampering.

(4) The present disclosure may be implemented as the above-described methods. The present disclosure may also be implemented as a computer program that realizes these methods via a computer, or may be implemented as digital signals generated by the computer programs.

The present disclosure may also be implemented by recording computer programs or digital signals on a computer-readable recording medium such as a flexible disk, a hard disk, a compact disc (CD)-ROM, a DVD, a DVD-ROM, a DVD-RAM, a Blu-ray (BD: registered trademark) disc, or semiconductor memory. The present disclosure may also be implemented as digital signals recorded on such a recording medium.

The present disclosure may be implemented by transmitting computer programs or digital signals via, for example, a telecommunication line, a wireless or wired communication line, a network typified by the Internet, or data communication.

The present disclosure may also be implemented as another independent computer system by transferring programs or digital signals recorded on a recording medium or by transferring programs or digital signals via a network or the like.

While various embodiments have been described herein above, it is to be appreciated that various changes in form and detail may be made without departing from the spirit and scope of the present disclosure as presently or hereafter claimed.

Further Information about Technical Background to this Application

The disclosures of the following patent applications including specification, drawings, and claims are incorporated herein by reference in their entirety: Japanese Patent Application No. 2024-039465 filed on Mar. 13, 2024 and Japanese Patent Application No. 2024-157078 filed on Sep. 11, 2024.

### INDUSTRIAL APPLICABILITY

The evaluation support system according to the present disclosure may, for example, be applicable to a device, a system, or the like that supports evaluations of an ECU or any other device incorporated into, for example, a vehicle.

The invention claimed is:

1. An evaluation support system for supporting an evaluation of an evaluation target device, the evaluation support system comprising:
memory that stores a program; and
a processor,
wherein the processor executes the program to operate as:
a threat concatenator that performs first association processing for concatenating at least part of threat analysis information with first evaluation specification information, the threat analysis information indicating a result of analysis of a threat to information security of the evaluation target device, the first evaluation specification information indicating one or more evaluation specifications of the evaluation target device;
a vulnerability concatenator that performs second association processing for concatenating at least part of vulnerability analysis information with the first evaluation specification information, the vulnerability analysis information indicating a result of analysis of vulnerability of the information security of the evaluation target device; and
a re-definer that generates and outputs second evaluation specification information by redefining, based on the first association processing and the second association processing, the one or more evaluation specifications indicated by the first evaluation specification information.

2. The evaluation support system according to claim 1,
wherein the first evaluation specification information indicates, for each evaluation item, an evaluation specification corresponding to the evaluation item, and
the threat concatenator performs the first association processing by concatenating, for each evaluation item in the first evaluation specification information, information indicating a countermeasure against the threat with the first evaluation specification information to associate the information with the evaluation specification corresponding to the evaluation item, the information indicating a result of analysis of the evaluation item and being included in the threat analysis information.

3. The evaluation support system according to claim 1,
wherein the first evaluation specification information indicates, for each evaluation item, an evaluation specification corresponding to the evaluation item, and
the vulnerability concatenator performs the second association processing by concatenating, for each evaluation item in the first evaluation specification information, identification information on the vulnerability with the first evaluation specification information to associate the identification information with the evaluation specification corresponding to the evaluation item, the identification information indicating a result of analysis of the evaluation item and being included in the vulnerability analysis information.

4. The evaluation support system according to claim 3,
wherein, when the vulnerability analysis information includes identification information on the vulnerability corresponding to a missing evaluation specification that is an evaluation specification not indicated by the first evaluation specification information, the re-definer re-defines the one or more evaluation specifications indicated by the first evaluation specification information by adding the missing evaluation specification and the identification information on the vulnerability corresponding to the missing evaluation specification to the first evaluation specification information that has undergone the first association processing and the second association processing.

5. The evaluation support system according to claim 1,
wherein the processor further operates as:
a feedback device that feeds back the second evaluation specification information as evaluated specification information to a threat analyzer and a vulnerability analyzer, the second evaluation specification information indicating a result of the evaluation of the evaluation target device obtained by the evaluation conducted in accordance with the second evaluation specification information,
the threat analyzer generates the threat analysis information by analyzing the threat to the evaluation target device, and
the vulnerability analyzer generates the vulnerability analysis information by analyzing the vulnerability of the evaluation target device.

6. An evaluation support system for supporting an evaluation of an evaluation target device, the evaluation support system comprising:
memory that stores a program; and
a processor,
wherein the processor executes the program to operate as:
a threat concatenator that performs first association processing for concatenating at least part of threat analysis information with first evaluation specification information, the threat analysis information indicating a result of analysis of a threat to information security of the evaluation target device, the first evaluation specification information indicating one or more evaluation specifications of the evaluation target device; and
a re-definer that generates and outputs second evaluation specification information by re-defining, based on the first association processing, the one or more evaluation specifications indicated by the first evaluation specification information.

7. The evaluation support system according to claim 6,
wherein the first evaluation specification information indicates, for each evaluation item, an evaluation specification corresponding to the evaluation item, and
the threat concatenator performs the first association processing by concatenating, for each evaluation item in the first evaluation specification information, information indicating a countermeasure against the threat with the first evaluation specification information to associate the information with the evaluation specification corresponding to the evaluation item, the information indicating a result of analysis of the evaluation item and being included in the threat analysis information.

8. The evaluation support system according to claim 6,
wherein, when the threat analysis information includes countermeasure information on a against the threat corresponding to a missing evaluation specification that is an evaluation specification not indicated by the first evaluation specification information, the re-definer re-defines the one or more evaluation specifications indicated by the first evaluation specification information by adding the missing evaluation specification and the information on the countermeasure against the threat corresponding to the missing evaluation specification to the first evaluation specification information that has undergone the first association processing.

9. The evaluation support system according to claim 6,
wherein the processor further operates as:
a feedback device that feeds back the second evaluation specification information as evaluated specification information to the threat analyzer, the second evaluation specification information indicating a result of the evaluation of the evaluation target device obtained by the evaluation conducted in accordance with the second evaluation specification information, and
the threat analyzer generates the threat analysis information by performing threat analysis on the evaluation target device.

10. An evaluation support system for supporting an evaluation of an evaluation target device, the evaluation support system comprising:
memory that stores a program; and
a processor,
wherein the processor executes the program to operate as:
a vulnerability concatenator that performs second association processing for concatenating at least part of analysis with vulnerability information first evaluation specification information, the vulnerability analysis information indicating a result of analysis of vulnerability of information security of the evaluation target device, the first evaluation specification information indicating one or more evaluation specifications of the evaluation target device; and
a re-definer that generates and outputs second evaluation specification information by re-defining, based on the second association processing, the one or more evaluation specifications indicated by the first evaluation specification information.

11. The evaluation support system according to claim 10,
wherein the first evaluation specification information indicates, for each evaluation item, an evaluation specification corresponding to the evaluation item, and
the vulnerability concatenator performs the second association processing by concatenating, for each evaluation item in the first evaluation specification information, identification information on the vulnerability with the first evaluation specification information to associate the identification information with the evaluation specification corresponding to the evaluation item, the identification information indicating a result of analysis of the evaluation item and being included in the vulnerability analysis information.

12. The evaluation support system according to claim 10,
wherein, when the vulnerability analysis information includes identification information on the vulnerability corresponding to a missing evaluation specification that is an evaluation specification not indicated by the first evaluation specification information, the re-definer re-defines the one or more evaluation specifications indicated by the first evaluation specification information by adding the missing evaluation specification and the identification information on the vulnerability corresponding to the missing evaluation specification to the first evaluation specification information that has undergone the second association processing.

13. The evaluation support system according to claim 10,
wherein the processor further operates as:
a feedback device that feeds back the second evaluation specification information as evaluated specification information to the vulnerability analyzer, the second evaluation specification information indicating a result of the evaluation of the evaluation target device obtained by the evaluation conducted in accordance with the second evaluation specification information, and
the vulnerability analyzer generates the vulnerability analysis information by performing vulnerability analysis on the evaluation target device.

14. An evaluation support method, executed by a computer, for supporting an evaluation of an evaluation target device, the evaluation support method comprising:
performing first association processing for concatenating at least part of threat analysis information with first evaluation specification information, the threat information indicating a result of analysis of a threat to information security of the evaluation target device, the first evaluation specification information indicating one or more evaluation specifications of the evaluation target device;
performing second association processing for concatenating at least part of vulnerability analysis information with the first evaluation specification information, the vulnerability analysis information indicating a result of analysis of vulnerability of the information security of the evaluation target device; and
generating and outputting second evaluation specification information by re-defining, based on the first association processing and the second association processing, the one or more evaluation specifications indicated by the first evaluation specification information.

15. An evaluation support method, executed by a computer, for supporting an evaluation of an evaluation target device, the evaluation support method comprising:
performing first association processing for concatenating at least part of threat analysis information with first evaluation specification information, the threat analysis information indicating a result of analysis of a threat to information security of the evaluation target device, the first evaluation specification information indicating one or more evaluation specifications of the evaluation target device; and
generating and outputting second evaluation specification information by re-defining, based on the first association processing, the one or more evaluation specifications indicated by the first evaluation specification information.

16. An evaluation support method, executed by computer, for supporting an evaluation of an evaluation target device, the evaluation support method comprising:
performing second association processing for concatenating at least part of vulnerability analysis information with first evaluation specification information, the vulnerability analysis information indicating a result of analysis of vulnerability of information security of the evaluation target device, the first evaluation specification information indicating one or more evaluation specifications of the evaluation target device; and
generating and outputting second evaluation specification information by re-defining, based on the second association processing, the one or more evaluation specifications indicated by the first evaluation specification information.
